(19) United States
(12) Patent Application Publication
(10) Pub. No.: US 2012/0242016 A1
(43) Pub. Date: Sep. 27, 2012

(54) DEVICE FOR HOLDING SILICON MELT

(76) Inventors: Bernhard Freudenberg, Coburg (DE); Josef Stenzenberger, Frelberg (DE); Michael Timm, Berlin (DE); Arve Solheim, Trondheim (NO); Håvard Sørheim, Trondheim (NO); Egbert van de Schootbrugge, Jonsvatnet (NO)

(21) Appl. No.: 13/513,336

(22) PCT Filed: Nov. 29, 2010
(86) PCT No.: PCT/EP2010/068378

§ 371 Date: Jun. 1, 2012

(30) Foreign Application Priority Data
Dec. 4, 2009 (EP) 09178059.3

(51) Int. Cl. B01L 3/04

(52) U.S. Cl. 266/242

(57) ABSTRACT

Device for holding a silicon melt comprising a crucible, which partly surrounds an inner chamber for holding the melt, with a base and at least one side wall made of a base material, whereby the crucible comprises at least one equalizing means for equalizing mechanical thermal stresses.

### CROSS REFERENCE TO RELATED APPLICATIONS

This application is a United States National Phase application of International Application PCT/EP2010/068378 and claims the benefit of priority under 35 U.S.C. §119 of European Patent Application 09 178 059.3 filed Dec. 4, 2009, the entire contents of which are incorporated herein by reference.

### FIELD OF THE INVENTION

The invention relates to a device for holding silicon melt.

### BACKGROUND OF THE INVENTION

Usually, in the field of melt metallurgy molds can only be used once. There is however a need for crucibles that can be used many times, in particular to reduce costs. It has been established that large volume crucibles are particularly prone to cracking, which is caused by inhomogeneous thermal expansion when melting silicon. As liquid silicon has a very low viscosity it is essential to avoid in a reliable manner the formation of open cracks to prevent damage to the furnace lining.

Vessels for directly or indirectly holding the melt of a semiconductor material are known from JP 3279289 A, JP 58009895 A, JP 58095693 A, JP 58190892 A and JP 60137893 A.

### SUMMARY OF THE INVENTION

The invention is therefore based on a problem of creating a device for holding silicon melt with an improved resistance to thermal stress.

This problem is solved by means of a device for holding a silicon melt comprising a crucible, which partly surrounds an inner chamber for holding the melt, with a base and at least one side wall made of a base material, wherein the crucible comprises at least one equalizing means for equalizing mechanical thermal stresses. The core of the invention consists in the fact that an equalizing means is provided in the crucible wall for equalizing mechanical thermal stresses. In this way the resistance to thermal stress is considerably increased.

Preferably, the equalizing means is arranged in the side wall of the crucible. In this area the temperature gradient is at its highest. Measures for preventing the formation of cracks are therefore particularly important.

In the simplest case the equalizing means is in the form of a cut-out, in particular an elongated slot. This makes it possible in a particularly simple manner to compensate for uneven thermal expansion.

In the present invention the wording substantially horizontal should be understood as comprising slots which are basically horizontal but whose precise orientation can vary depending of the method of making slots. The slots can be made by handsaw, sawn by different suitable machineries, angle grinder of different kinds or similar tools. Further, the slots can also be made during the production of a crucible.

For the given purpose it is sufficient for the slot to have a width of in the region of 0.1 mm to 100 mm. Preferably, widths are in the order of magnitude of a few millimeters.

To prevent the cracking of the crucible at the end of the slot, the slot preferably has a rounded end, which is preferably slightly wider than the width of the slot.

Advantageously, the slot is arranged in the half of the side wall furthest away from the base of the crucible. In this way the slot can preferably be designed so that during the melting of the silicon in the crucible its lowest point is always higher than the melt. In this case, no further, special precautions are necessary to prevent the melt from running out through the slot.

With a slot that is open at the end furthest from the base any stresses in the side wall are avoided in a particularly efficient manner.

Filling the slot with a filler material, in particular powder packing, prevents the melt running out through the slot in a particularly simple and efficient manner.

By specifically selecting a material with a specific thermal conductivity coefficient the thermo-mechanical properties of the crucible can be adapted to the corresponding requirements.

Series of trials have shown that multiple use crucibles can be produced with a cross sectional area of up to 90×90 cm² and greater.

By having an edge strip with a lower thermal conductivity coefficient than the base material of the crucible the temperature gradient in the crucible can be reduced.

The displaceability of the side wall relative to the base of the crucible prevents the formation of cracks in the transitional area between the latter.

According to the invention a device for holding a silicon melt comprises a crucible, which partly surrounds an inner chamber for holding the melt, with a base and at least one side wall made of a base material, wherein the crucible comprises at least one equalizing means for equalizing mechanical thermal stresses. Preferably the equalizing means is arranged in the at least one side wall.

Preferably the equalizing means is designed in the form of a slot with slot edges, wherein the slot edges are designed in particular to be parallel at least in sections or run towards one another.

Preferably one or more substantially horizontal slots are arranged in one or more of the side walls.

Preferably the one or more substantially horizontal slots extend circularly through all side walls.

Preferably the one or more substantially horizontal slots extend non circularly but partly in one or more side walls.

Preferably two or more horizontal slots are arranged without substantial horizontal overlap.

Preferably the slot at one end comprises a crack-preventer in the form of a rounding, whereby the rounding preferably has a radius of curvature, which is at least as large, in particular at least one and a half times as large, preferably at least twice as large as the width of the slot.

Preferably the at least one slot is arranged in the half of the side wall furthest from the base.

Preferably the at least one slot is open as its end furthest from the base.

Preferably the equalizing means is filled at least partly with a filler material, whereby the filler material is a tightly packed powder, in particular a combination of the elements silicon, nitrogen and/or oxygen.

Preferably the side wall for reducing the temperature gradient comprises at least one area of inhomogeneous thermal conductivity.

Preferably the inner chamber has in particular a quadratic, cross sectional area of at least 400 cm² and preferably 8,100 cm² to 12,100 cm².

Preferably in the region of one free end of the side wall opposite the base at least one cover strip is provided, whereby the cover strip is preferably made of a material with a thermal conductivity coefficient (λ_{L}), which is at least as high as the thermal conductivity coefficient (λ_{S}) of the base material, λ_{L}≦λ_{S}, in particular λ≦0.9×λ_{S}.

Preferably the cover strip covers the free end of the side wall by at least 50%, in particular at least 80%, preferably completely.

Preferably the side wall is designed at least in part to be displaceable relative to the base, in particular to be removable from the base.

Preferably the base has a lateral edge, which surrounds the side wall peripherally.

Preferably between the edge of the base and the side wall a free space is formed, which is filled with a filler material for sealing the crucible.

Preferably the base is made at least partly from a first material with a thermal conductivity coefficient (λ_{B}) and the side wall is made at least partly of a second material with a thermal conductivity coefficient (λ_{S}), whereby X_{B} differs from X_{S}, in particular λ_{B}>λ_{S}.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a crucible according to an exemplary embodiment of the invention;

FIG. 2 is an enlarged view of a section of area II of FIG. 1;

FIG. 3 is an enlarged view of a section of area III of FIG. 1;

FIG. 4 is a schematic view of a crucible according to an exemplary embodiment of the invention;

FIG. 5 is a cross sectional view of the side wall of the crucible according to FIG. 4;

FIG. 6 is a view according to FIG. 5 according to an exemplary embodiment of the invention;

FIG. 7 is a cross sectional view of a crucible according to an exemplary embodiment of the invention;

FIG. 8 is a partial cross sectional view of a crucible according to a further exemplary embodiment of the invention;

FIG. 9 is a view according to FIG. 8 of a further embodiment of the invention;

FIG. 10 is a view according to FIG. 9 of a further embodiment of the invention;

FIG. 11 is a schematic view of the embodiment according to FIG. 10;

FIG. 12 is a view of a crucible according to an exemplary embodiment of the invention; and

FIG. 13 is a view according to another exemplary embodiment of the invention.

### DESCRIPTION OF THE PREFERRED EMBODIMENTS

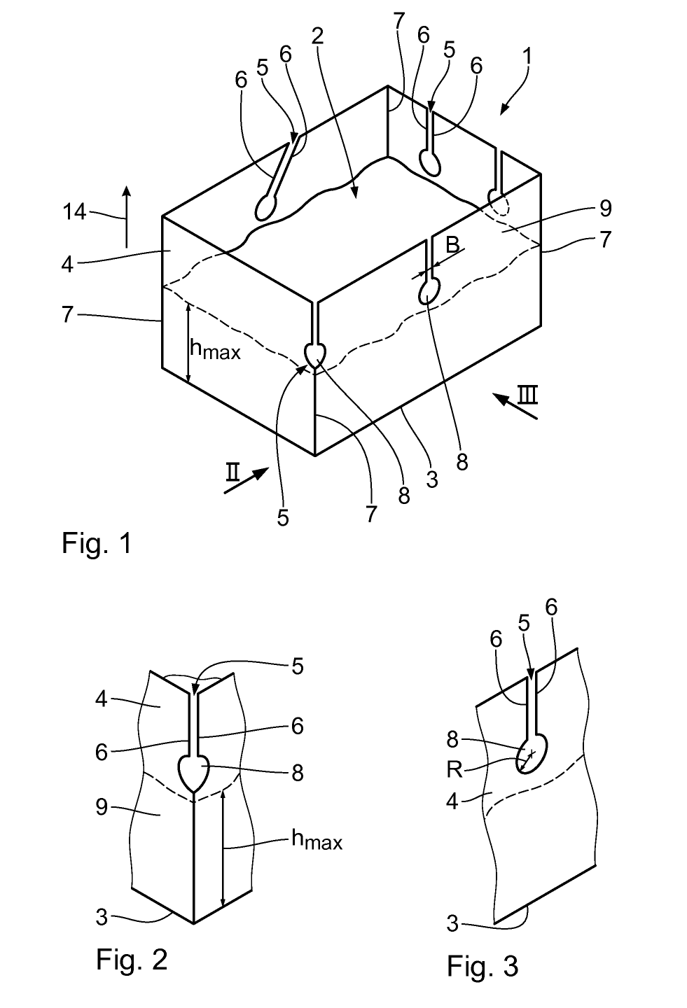

In the following an exemplary embodiment of the invention is described with reference to FIGS. 1 to 3. A device according to the invention for holding a silicon melt comprises a crucible 1, which surrounds an inner chamber 2 for holding the melt at the bottom and around the edge. The crucible 1 comprises a base 3 and four side walls 4. The side walls 4 are arranged parallel to a longitudinal direction 14. They can also be aligned obliquely to the longitudinal direction 14 for easier removal of the hardened melt 9 from the crucible 1.

The inner chamber 2 has a rectangular design. It thus has a rectangular, preferably a quadratic cross sectional area Q. The side length of the cross section Q of the inner chamber 2 is at least 20 cm and preferably 90 to 110 cm. The cross sectional area Q is thus at least 400 cm² and preferably 8,100 to 12,100 cm². In principle, a crucible 1 with an alternative, in particular a round cross section, is also possible.

The inner chamber 2 is delimited by the crucible 1 in a liquid-tight manner from the outside.

The base 3 and the side walls 4 are made of a base material. The base material has a thermal conductivity coefficient λ_{S}. The base material preferably has a low longitudinal expansion coefficient α_{B}. The longitudinal expansion coefficient α_{B} is in particular less than 20×10⁻⁶ K⁻¹, preferably less than 5×10⁻⁶ K⁻¹, preferably less than 3.5×10⁻⁶ K⁻¹. The base material can be selected in particular from silicon nitride and/or silicon carbide and/or a different silicon-ceramic.

To equalize mechanical stresses, which may be caused by the uneven thermal expansion of the crucible 1 when heating or cooling the latter, at least one cut-out is provided in the side walls 4. The cut-out is designed in particular as a slot 5 with slot edges 6. The slots 5 form an equalizing means for equalizing thermo-mechanical stresses. In general, the equalizing means has a thermal conductivity coefficient λ, which differs from that of the base material.

Various alternatives are possible for the design and arrangement of the slots 5. The slots 5 are arranged in a side wall 4. Depending on the size of the crucible 1 one or more slots 5 can be provided on each side wall 4. It is also possible, to arrange the slots 5 in an area of a side edge 7 of the crucible 1 where two side walls 4 abut with one another. The slots 5 each have a width B of in the region of 0.1 mm to 100 mm, in particular less than 10 mm, preferably less than 5 mm. At one end the slots have a crack-preventer in the form of a rounding 8 to prevent the cracking of the crucible 1. The rounding has a radius of curvature R of at least 0.05 mm, in particular at least 0.1 mm, in particular at least 0.25 mm, in particular at least 0.75 mm. Preferably, the radius of curvature R of the rounding 8 is at least as large, in particular at least one and a half times as large, preferably at least twice as large as the width B of the slot 5. The slots 5 are designed to be open at their other end furthest from the base 3. They are preferably oriented to be vertical. They can however also run obliquely or horizontally in the side wall 4. According to the exemplary embodiment described with reference to FIGS. 1 to 3 of the invention, the slots 5 are arranged respectively in the half of the side wall 4 furthest from the base 3. They are arranged in particular such that their lowest point lies above the maximum filling level hₘₐₓ of the melt 9 in the crucible 1.

The slot edges 6 are aligned to be parallel to one another. They can also be designed to run conically towards the inner chamber 2 or to widen towards the inner chamber 2.

To produce the crucible 1 according to the invention the slots 5 are made in the side walls prior to sintering. Alternatively, the slots 5 are made in a pre-sintered crucible 1 or formed in the latter after the sintering of the crucible 1.

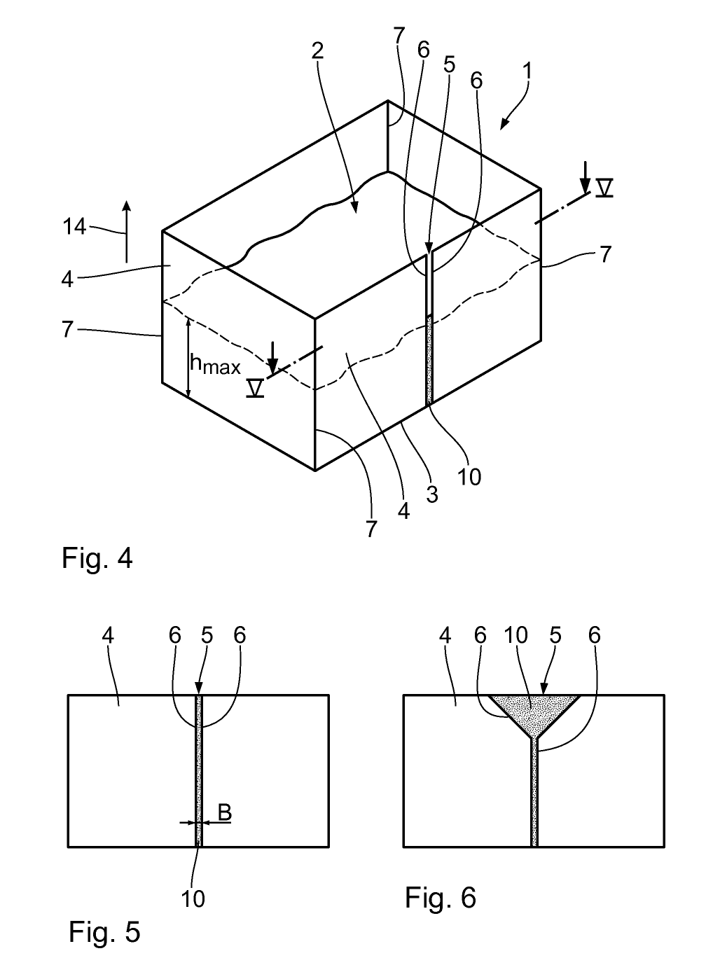

In the following, with reference to FIGS. 4 to 6 another embodiment of the invention is described. Identical parts are given the same reference numbers as in the exemplary embodiment described with reference to FIGS. 1 to 3, the description of which is referred to here. In this exemplary embodiment the slots 5 extend below the maximum filling height hₘₐₓ of the melt 9 in the crucible 1. As shown in FIG. 4, the slot 5 can extend in particular along the entire height of the side wall 4. In principle, it is also possible to have a slot 5 in the base 3. In order to prevent the melt 9 running out, the slot 5 is filled at least up to the maximum filling level hₘₐₓ with a filler material 10. Preferably, the slot 5 is filled completely with the filler material 10. The filler material is preferably a tightly packed powder, which is also referred to as powder packing The powder packing is preferably a metallic non-wetted material. The filler material 10 fills the slot 5 in a sealing manner. The filler material 10 comprises in particular a combination of the elements silicon, nitrogen and/or oxygen. For insertion into the slot 5 the filler material 10 can comprise organic and/or inorganic additives, for example vinyl and/or acetate and/or cellulose. It can also contain up to 1% of a liquefier and/or up to 5% of a binding agent. Further injection molding additives are also possible. To insert the filler materials 10 into the slot 5 an injection method is used, in particular a powder injection molding method, preferably a ceramic powder injection molding method (CIM). Alternative methods are also possible however.

According to the variant represented in FIG. 5 the slot edges 6 are arranged parallel to one another. According to an alternative variant shown in FIG. 6, the slot 5 has a cross section with a wedge-shaped area.

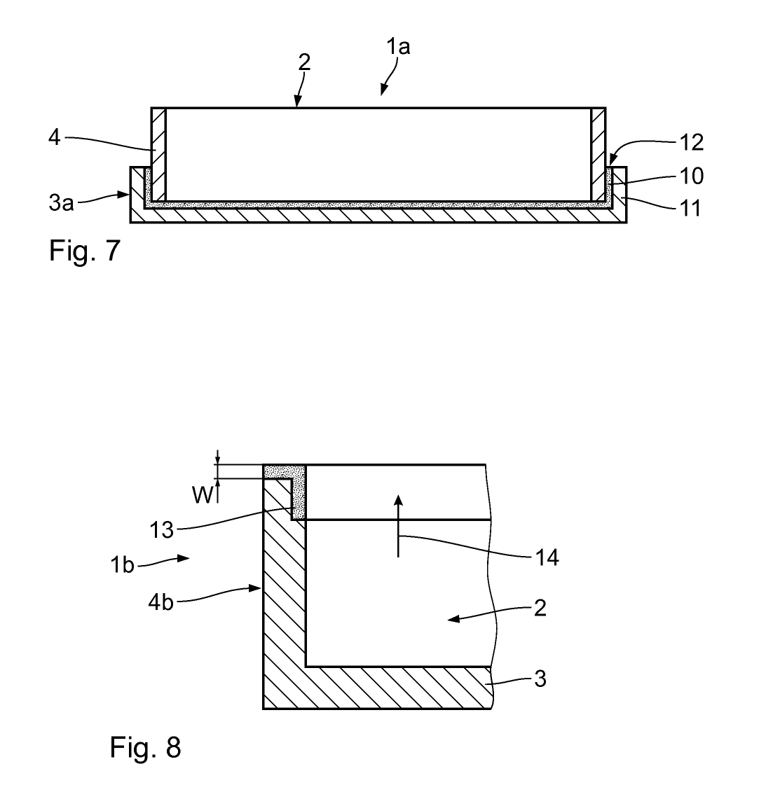

In the following with reference to FIG. 7 another exemplary embodiment of the invention is described. Identical parts have the same reference numbers as in the preceding exemplary embodiments, the description of which is referred to here. Structurally different, but functionally similar parts have been given the same reference numbers with an additional a. The difference from the preceding exemplary embodiments is that, in the exemplary embodiment according to FIG. 7, the side walls 4 are arranged displaceably relative to the base 3a. In this case the side walls 4 are still connected in a liquid-tight manner to the base 3. The side walls 4 can be connected in particular in a removable manner to the base 3a. The base 3a has a lateral edge 11, which surrounds the side walls 4 around the outside. The edge 11 is arranged in particular to be parallel to the side walls 4. Between the edge 11 of the base 3a and the side wall 4 a free space 12 is formed. The free space 12 is filled with a filler material 10 for sealing the crucible 1a. In this way a liquid-tight connection is ensured between the side walls 4 and the base 3a. Preferably, the base 3a is completely covered with filler material 10. In this way at the same time as sealing the crucible 1a any adhesion of the melt 9 to the base 3a can be prevented. For details about the filler material 10 reference is made to the preceding exemplary embodiment.

The base 3a can be made at least in sections from a material with a thermal conductivity coefficient λ_{B}, which differs from the thermal conductivity coefficient λ_{S} of the material of the side wall 4. In particular the value is λ_{B}>λ_{S}.

Of course, the crucible 1a can comprise one or more equalizing means according to the preceding exemplary embodiments.

In a preferred embodiment the crucible 1a works together with a furnace, not shown in FIG. 7, so that closing the furnace leads to the pressing of the side wall 4 onto the base 3a with a defined force. In this way the tightness of the crucible 1a is ensured in a particularly reliable manner.

In another embodiment of the present invention, removable side walls 4 are arranged at a bottom plate as the base 3. According to this embodiment said bottom plate is equipped with depressed slots. This embodiment is not shown in the figures. The inside of the sidewalls arranged at the depressed slots of the bottom plate can also be coated by a chosen silicon containing material.

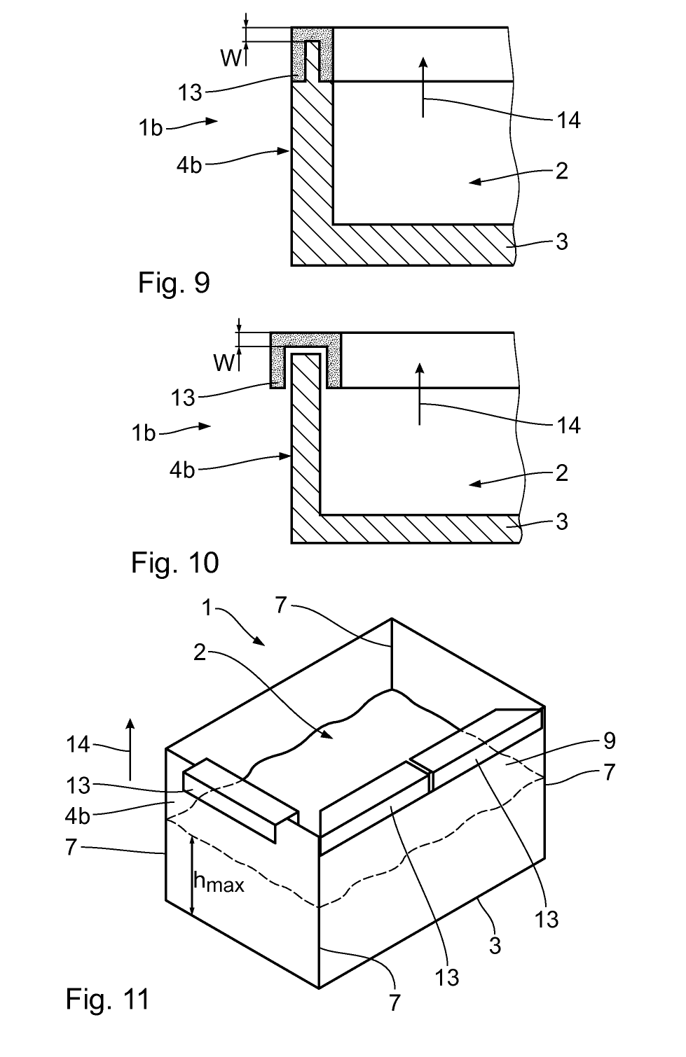

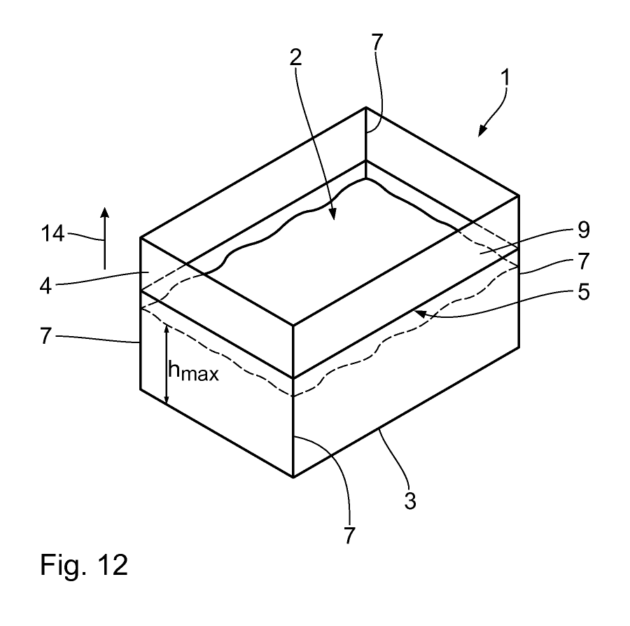

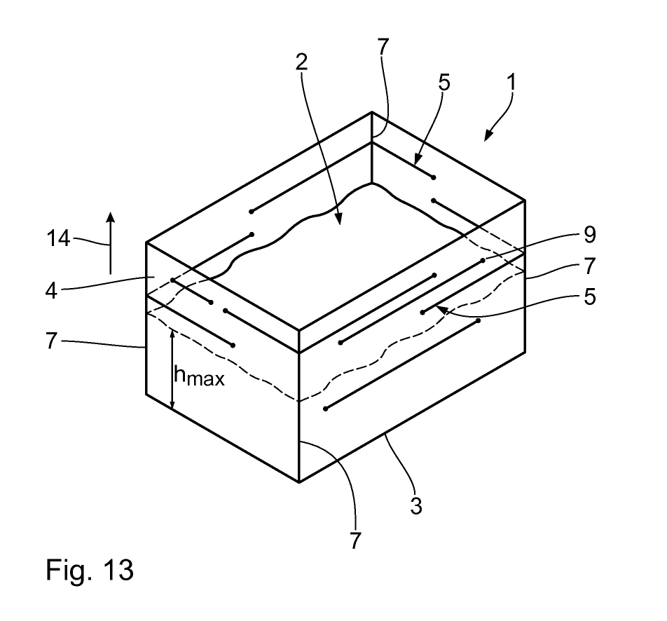

In the following with reference to FIGS. 8 to 13 several variants of a further exemplary embodiment of the invention are described. Identical parts are given the same reference numbers as in the previous exemplary embodiments, the description of which is referred to here. Structurally different, but functionally similar parts have the same reference numbers with an additional b. According to these exemplary embodiments, the side wall 4b in the region of its end remote from the base comprises one or more cover strips 13. Thus the side wall 4b to reduce the temperature gradient in longitudinal direction 14 has an area of inhomogeneous thermal conductivity.

The cover strip 13 is preferably designed to be peripheral. It covers at least 50%, in particular at least 80% of the free edge of the side wall 4b. Preferably, the cover strip 13 covers the entire peripheral edge of the side wall 4b. The cover strip 13 has in longitudinal direction 14 a wall thickness W of at least 2 mm, in particular at least 5 mm. The cover strip 13 has an extension in longitudinal direction 14. The extension of the cover strip 13 is in particular at most 50%, in particular at most 30%, in particular at most 10% of the extension of the side wall 4.

The cover strip 13 can be designed to be of one piece. Preferably, the cover strip 13 is designed to consist of several pieces. The cover strip 13 can comprise in particular one or more pieces per side wall 4. In this way cracks caused by thermal stresses are prevented from being formed in the crucible 1b between the cover strip 13 and the side wall 4. The cover strip 13 can lie loosely on the side wall 4b. It is then displaceable in particular in a direction perpendicular to the longitudinal direction 14 against the side wall 4b. Alternatively, the cover strip 13 can rest in a form-closed manner on the side wall 4b. It can, as shown in the Figures, have an L- or U-shaped cross section. A rectangular cross section is also possible. The cover strip 13 can be designed in particular as an aligned extension of the side wall 4b. This variant corresponds essentially to the exemplary embodiment of the invention described with reference to FIGS. 1 to 3 with a peripheral slot 5 running parallel to the base 3 with an infinitesimal width B. In other words, the side wall 4 in this variant is provided with a peripheral subdivision. The subdivision runs obliquely, in particular perpendicular to the longitudinal direction 14. It can run parallel to the base 3 or obliquely in relation to the latter. The subdivision can also be profiled, as shown in FIGS. 8 and 10, for example stepped, in particular L-, V- or U-shaped.

The cover strip 13 is made from a material with a thermal conductivity coefficient λ_{L}, which is at most as great as the thermal conductivity coefficient λ_{S} of the side wall 4, preferably λ_{L}≦λ_{S}, in particular λ≦0.9×λ_{L}. The material for the cover strip 13 can be selected for example from reaction bonded silicon nitride (RBSN) and/or nitrite bonded silicon nitride (NBSN) with a lower density. NBSN with lower density has a greater porosity and therefore a lower thermal conductivity than RBSN.

The cover strip 13 can also comprise an outer strip 15. The outer strip 15 is arranged on the outside of the crucible 1b. It is firmly secured to the inner part of the cover strip 15, in particular adhered. The outer strip 15 is made of graphite for example.

The features of the various exemplary embodiments, in particular the equalizing means designed as a cut-out or subdivision, the side wall 4 connected removably with the base 3a and the side wall 4 with an area of inhomogeneous thermal conductivity, in particular with cover strips 13, can of course be combined freely with one another.

The crucibles 1, 1a, 1b according to the invention have a reduced tendency to crack and an improved resistance to thermal stress. They are therefore particularly suitable for multiple use.

FIG. 13 shows a crucible with horizontal slot 5 above the surface of the melt 9. The slot level in the side wall 4 can vary in longitudinal direction 14 and can be arranged above or below the melt level. For slot level below the melt level an application of filler material 10 is to be used. The substantially horizontal extension of the slots 5 can vary. The slot 5 can be arranged around all side walls 4 or partly at one or more side walls 4.

Another embodiment of the invention is to provide more than one substantially horizontal slot 5 at different slot levels in the side wall 4. Those substantially horizontal slots 5 can be arranged circular at all side walls 4 or partly at one or more side walls 4. A preferred embodiment is the arrangement of several non circular slots at different slot levels with or without substantial horizontal overlapping as shown in FIG. 13.

While specific embodiments of the invention have been shown and described in detail to illustrate the application of the principles of the invention, it will be understood that the invention may be embodied otherwise without departing from such principles.

1. A device for holding a silicon melt, comprising:
a crucible which partly surrounds an inner chamber for holding the melt, with a base and at least one side wall made of a base material, wherein the crucible comprises at least one equalizing means for equalizing mechanical thermal stresses.

2. A device according to claim 1, wherein the equalizing means is arranged in the at least one side wall.

3. A device according to claim 1, wherein the equalizing means is designed in the form of a slot with slot edges.

4. A device according to claim 1, wherein one or more substantially horizontal slots are arranged in one or more side walls.

5. A device according to claim 4, wherein the one or more substantially horizontal slots extend circularly through all side walls.

6. A device according to claim 4, wherein the one or more substantially horizontal slots extend non circularly but partly in one or more side walls.

7. A device according to claim 5, wherein two or more horizontal slots are arranged without substantial horizontal overlap.

8. A device according to claim 3, wherein the slot at one end comprises a crack-preventer in the form of a rounding.

9. A device according to claim 3, wherein the at least one slot is arranged in a half of the side wall furthest from the base.

10. A device according to claim 3, wherein the at least one slot is open at an end furthest from the base.

11. A device according to claim 3, wherein the equalizing means is filled at least partly with a filler material, whereby the filler material is a tightly packed powder.

12. A device according to claim 1, wherein the side wall for reducing a temperature gradient comprises at least one area of inhomogeneous thermal conductivity.

13. A device according to claim 1, wherein the inner chamber has a quadratic, cross sectional area of at least 400 cm².

14. A device according to claim 1, wherein in a region of one free end of the side wall opposite the base at least one cover strip is provided.

15. A device according to claim 14, wherein the cover strip covers a free end of the side wall by at least 50%.

16. A device according to claim 1, wherein the side wall is designed at least in part to be displaceable relative to the base.

17. A device according to claim 1, wherein the base has a lateral edge, which surrounds the side wall peripherally.

18. A device according to claim 17, wherein a free space is formed between the lateral edge of the base and the side wall, said free space being filled with a filler material for sealing the crucible.

19. A device according to claim 1, wherein the base is made at least partly from a first material with a first material thermal conductivity coefficient and the side wall is made at least partly of a second material with a second material thermal conductivity coefficient, whereby said first material thermal conductivity coefficient differs from said second material thermal conductivity coefficient.

20. A device according to claim 1, wherein the equalizing means is designed in the form of a slot with slot edges, wherein the slot edges are designed to be parallel at least in sections or extend towards one another.

21. A device according to claim 3, wherein the slot at one end comprises a crack-preventer in the form of a rounding, whereby the rounding has a radius of curvature, which is at least as large as a width of the slot.

22. A device according to claim 3, wherein the slot at one end comprises a crack-preventer in the form of a rounding, whereby the rounding has a radius of curvature, which is at least one and a half times as large as a width of the slot.

23. A device according to claim 3, wherein the slot at one end comprises a crack-preventer in the form of a rounding, whereby the rounding has a radius of curvature, which is at least twice as large as a width of the slot.

24. A device according to claim 3, wherein the equalizing means is filled at least partly with a filler material, whereby the filler material is a combination of elements of at least one of silicon, nitrogen and oxygen.

25. A device according to claim 1, wherein the inner chamber has a quadratic, cross sectional area of 8,100 cm² to 12,100 cm².

26. A device according to claim 1, wherein in a region of one free end of the side wall opposite the base at least one cover strip is provided, whereby the at least one cover strip is made of a material with a thermal conductivity coefficient (λ_{L}), which is at least as high as a thermal conductivity coefficient (λ_{S}) of the base material, λ_{L}≦λ_{S}.

27. A device according to claim 1, wherein in a region of one free end of the side wall opposite the base at least one cover strip is provided, whereby the at least one cover strip is made of a material with a thermal conductivity coefficient (λ_{L}), which is at least as high as a thermal conductivity coefficient (λ_{S}) of the base material, λ≦0.9×λ_{S}.

28. A device according to claim 14, wherein the cover strip covers a free end of the side wall by at least 80%.

29. A device according to claim 14, wherein the cover strip completely covers a free end of the side wall.

30. A device according to claim 1, wherein the side wall is designed at least in part to be removable from the base.

31. A device according to claim 1, wherein the base is made at least partly from a first material with a first material thermal conductivity coefficient and the side wall is made at least partly of a second material with a second material thermal conductivity coefficient, whereby said first material thermal conductivity coefficient is greater than said second material thermal conductivity coefficient.
